(19) United States
(12) Patent Application Publication
(10) Pub. No.: US 2023/0202914 A1
(43) Pub. Date: Jun. 29, 2023

(54) ULTRA-THIN GLASS AND METHOD FOR MANUFACTURING SAME

(71) Applicant: DONGWOO FINE-CHEM CO., LTD., Jeollabuk-do (KR)

(72) Inventors: Tae-Gyun KIM, Pyeongtaek (KR); Seung-June PARK, Yongin (KR); Jae-Woo JEONG, Pyeongtaek (KR); Jong-Min KIM, Hwaseong (KR)

(21) Appl. No.: 17/927,188

(22) PCT Filed: May 6, 2021
(86) PCT No.: PCT/KR2021/005635

§ 371 Date: Nov. 22, 2022

(30) Foreign Application Priority Data
May 22, 2020 (KR) 10-2020-0061813

(51) Int. Cl. C03C 21/00; C03C 15/00

(52) U.S. Cl. CPC C03C 21/002; C03C 15/00

(57) ABSTRACT

The present invention relates to an ultra-thin glass having a thickness (t), characterized in that, when the first surface is defined as a point (t₀) with t=0, and the second surface is defined as a point (tₜ) with t=t, the point (t_{Kmax}) at which the concentration of potassium ions (K⁺) is maximum between t₀ and tₜ satisfies at least one of Equations 1 and 2 below, and the ultra-thin glass has a bend radius of less than 26·t, and a method for manufacturing the same.

t₀<t_{Kmax}≤0.5·tₜ [Equation 1]

0.5·tₜ≤t_{Kmax}<tₜ. [Equation 2]

### TECHNICAL FIELD

The present disclosure relates to an ultra-thin glass having improved bending resistance and a method for manufacturing the same.

### BACKGROUND ART

A flexible display is a display that can be bent or folded, and various technologies and patents are being proposed. When the display is designed in a foldable form, it can be used as a tablet if it is unfolded and as a smartphone if folded so that displays with different sizes can be used as one product. In addition, in the case of larger-sized devices such as tablets and TVs rather than small-sized smartphones, convenience can be doubled if they can be folded and carried around.

In the case of a normal display, a cover window made of a glass material is provided at the outermost part to protect the display. However, in the case of a conventional glass material, it is impossible to apply it to a foldable display, therefore, it is essential to develop a material of a glass material having bending resistance that can be applied to a foldable display or the like.

In general, chemically strengthened glass is a product that generates surface stress (or compressive stress (CS)) on the surface by substituting alkaline ions such as lithium (Li) and sodium (Na) having a small ionic radius that exist up to a certain depth (Depth Of Layer; DOL) from the surface layer with potassium ions (K⁺) having a relatively large ionic radius. The chemical strengthening effect is expressed as a mechanism to prevent the stress caused by impact from propagating to the inside due to the compressive stress of this surface layer.

DOL refers to the depth at which stress in chemically strengthened glass changes from compressive to tensile stress. In DOL, the stress crosses from compressive stress to tensile stress, thus maintaining the shape as a balance between compressive stress and tensile stress.

The internal stress (CT) is calculated from the compressive stress (CS) of a chemically strengthened glass, the depth of layer (DOL), and the thickness (t) of the glass by General Formula below.

CT=(CS×DOL)/(t−2×DOL) <General Formula>

According to conventions commonly used in the art, unless otherwise stated, compression is expressed as a negative (<0) stress and tension is expressed as a positive (>0) stress. However, throughout the present specification, when speaking about compressive stress (CS), it is given regardless of a positive or negative value, i.e., as described herein, CS=|CS|.

Compressive stress (CS) and potassium ions'(K⁺) penetration depth (DOL) can be measured using a means known in the art, but it is difficult to measure with a surface stress meter in ultra-thin glass of 100 μm or less. Even if it is measured, reliability is low so that evaluation was performed using Energy Dispersive X-ray Spectroscopy (EDS) or Electron Probe Micro Analyzer (EPMA) in the present disclosure.

Meanwhile, Korean Patent No. 10-1684344 discloses a method for improving the flexural strength of glass that can be bent up to a radius of curvature of 2 R. However, since the maximum radius of curvature is 2 R, and the method comprises a number of manufacturing processes, there is a disadvantage in terms of economic efficiency of the process.

### DISCLOSURE

### Technical Problem

An object of the present disclosure is to provide an ultra-thin glass having improved bending resistance.

Another object of the present disclosure is to improve the economic efficiency of a process for manufacturing an ultra-thin glass having improved bending resistance.

### Technical Solution

The present disclosure relates to an ultra-thin glass having a thickness (t), characterized in that, when the first surface is defined as a point (t₀) with t=0, and the second surface is defined as a point (tₜ) with t=t, the point (t_{Kmax}) at which the concentration of potassium ions (K⁺) is maximum between to and tₜ satisfies at least one of Equations 1 and 2 below, and the ultra-thin glass has a bend radius of less than 26·t.

t₀<t_{Kmax}≤0.5·tₜ [Equation 1]

0.5·tₜ≤t_{Kmax}<tₜ. [Equation 2]

In the first aspect of the present disclosure, t_{Kmax} may be formed at a depth of 2% to 30% of the depth of layer.

In the second aspect of the present disclosure, the depth of layer may be formed by including at least one region of a first strengthening region ts₁ defined as a region satisfying t₀<ts₁≤0.5·tₜ and a second strengthening region ts₂ defined as a region satisfying 0.5·tₜ≤ts₂<tₜ.

In the third aspect of the present disclosure, the first strengthening region ts₁ may be defined as a region satisfying t₀<ts₁≤0.3 tₜ, and the second strengthening region ts₂ may be defined as a region satisfying 0.7·tₜ≤ts₂<tₜ.

In the fourth aspect of the present disclosure, the ultra-thin glass may be formed by removing a region included in t₀ to 0.05·tₜ with respect to the surface of the ultra-thin glass before polishing.

In the fifth aspect of the present disclosure, it may be formed by further removing a region included in 0.95·tₜ to tₜ.

According to the sixth aspect of the present disclosure, the thickness (t) may be 20 μm to 100 μm.

In the seventh aspect of the present disclosure, the ultra-thin glass may have a breaking strength of 1,200 Mpa or more.

The present disclosure relates to a method for manufacturing an ultra-thin glass, the method comprising the steps of: (a) preparing an ultra-thin glass; (b) performing chemical strengthening through an ion displacement solution; and (c) performing chemical polishing through a chemical polishing solution, wherein the ultra-thin glass with a thickness (t) manufactured by the manufacturing method has a bend radius of less than 26·t.

In the eighth aspect of the present disclosure, the step (a) of preparing an ultra-thin glass may include a step of etching one or both surfaces of the glass using an etchant.

In the ninth aspect of the present disclosure, the step (b) of performing chemical strengthening may include a step of raising the temperature before immersing the ultra-thin glass in the ion displacement solution.

In the tenth aspect of the present disclosure, the step (c) of performing chemical polishing may be a step of performing polishing such that the thickness of the ultra-thin glass after polishing is 90% or more and less than 100% of the thickness of the ultra-thin glass before polishing.

In the eleventh aspect of the present disclosure, the ion displacement solution may contain potassium nitrate (KNO₃).

In the twelfth aspect of the present disclosure, the chemical polishing solution may contain one or more of hydrofluoric acid (HF) and ammonium fluoride (NH₄F).

According to the present disclosure and the first to twelfth aspects, it is possible to improve the bending resistance of the ultra-thin glass.

### Advantageous Effects

The ultra-thin glass according to embodiments of the present disclosure may have improved bending resistance.

Further, according to the method for manufacturing an ultra-thin glass according to the present disclosure, it is possible to manufacture an ultra-thin glass having improved bending resistance compared to a conventional method for manufacturing an ultra-thin glass.

### DESCRIPTION OF DRAWINGS

FIG. 1 is a view showing a stress profile of a conventional chemically strengthened glass.

FIG. 2 is a view showing a stress profile of an ultra-thin glass, which is one embodiment of the present disclosure.

FIG. 3 is a view showing a concentration profile of potassium ions (K⁺) inside the conventional chemically strengthened glass.

FIG. 4 is a view showing a concentration profile of potassium ions (K⁺) inside an ultra-thin glass as one embodiment of the present disclosure.

FIG. 5 is a view showing a concentration profile of potassium ions (K⁺) inside an ultra-thin glass as another embodiment of the present disclosure.

FIG. 6 is a graph showing bend radiuses of Examples and Comparative Examples.

FIG. 7 is a view showing the contents of components by each depth of the ultra-thin glass, which is one embodiment of the present disclosure.

FIG. 8 is views showing the profile of potassium ions (K⁺) for each depth of ultra-thin glasses of Examples 4 to 7.

### BEST MODE FOR CARRYING OUT THE INVENTION

The present disclosure relates to an ultra-thin glass applicable to a flexible display by having improved bending resistance and a method for manufacturing the same, which are focused on to the fact that internal stress, surface stress (or compressive stress), etc. can be adjusted depending on the amount of potassium ions (K⁺) contained in the ultra-thin glass, the depth of layer, etc., and accordingly, the bending resistance of the ultra-thin glass can be improved.

More specifically, the present disclosure is characterized in that, when the first surface is defined as a point to where t=0 and the second surface is defined as a point tₜ where t=t in an ultra-thin glass having a thickness (t), a point (tₖₘₐₓ) at which the concentration of potassium ions (K⁺) is maximum between t₀ and tₜ is inside the glass except for the to point and/or the tₜ point.

Specifically, the present disclosure relates to an ultra-thin glass allowing the point (t_{Kmax}) at which the concentration of potassium ions (K⁺) is maximum to be in a region between the point close to the tₜ point and the 0.5 tₜ point, except for the to point, or in a region up to a point close to the tₜ point, except for the 0.5 tₜ point to the tₜ point, and a method for manufacturing the same. There may be provided an ultra-thin glass which has maximized bending resistance by being characterized in that the ultra-thin glass having a thickness (t) has a bend radius of less than 26·t.

In order for those skilled in the art belonging to the technical field of the present disclosure to clearly understand and easily reproduce the configuration of the invention, the meaning of ‘the bend radius of less than 26·t’ used throughout the present specification will be described in detail below.

For example, when the thickness of the ultra-thin glass is 50 μm, the meaning of ‘the bend radius is less than 26·t’ means that the bend radius is formed to be less than 26×50 μm.

That is, the bend radius is less than 1,300 μm (1.3 mm), and this can be interpreted as the same meaning as 1.3 R, which is an expression commonly used in the art.

Hereinafter, preferred embodiments of the present disclosure will be described in detail by classifying the items into ┌ultra-thin glass┘ and ┌method for manufacturing ultra-thin glass┘.

The terms used in the present specification are for describing the mode for carrying out the present disclosure, and are not intended to limit the present disclosure. In the present specification, the singular forms also include the plural forms unless specifically stated otherwise in the phrase.

┌Comprise┘ and/or ┌comprising┘ used in the specification is used in the sense of not excluding the existence or addition of one or more other components, steps, operations and/or elements other than the mentioned component, step, operation and/or element.

In the present specification, ┌compressive stress┘, ┌surface stress┘, and ┌CS┘ are used with the same meaning, and ┌tensile stress┘, ┌internal stress┘, and ┌CT┘ are used with the same meaning.

┌Ultra-Thin Glass┘

The ultra-thin glass according to the present disclosure is characterized in that it is formed by including potassium ions (K⁺) to improve bending resistance. Particularly, the ultra-thin glass according to the present disclosure is one which maximizes bending resistance as the concentration of potassium ions (K⁺) satisfies at least one of the following Equations 1 and 2, and characterized by having a bend radius of less than 26·t.

t₀<t_{Kmax}≤0.5·tₜ [Equation 1]

0.5·tₜ≤t_{Kmax}<tₜ. [Equation 2]

In Equations 1 and 2, t is a thickness of the ultra-thin glass; t₀ is a point where t=0 and means the first surface; and tₜ is a point where t=t and means the second surface.

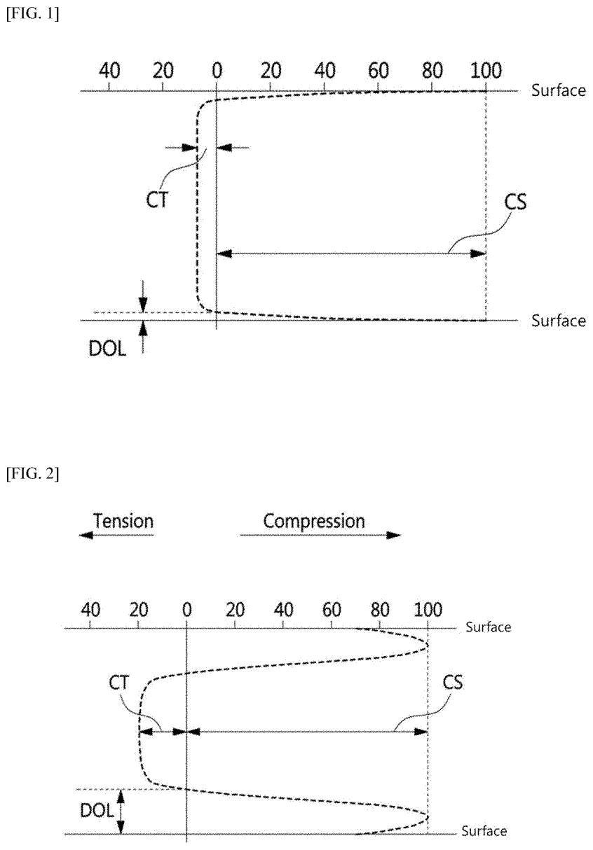

FIG. 1 is a view showing a stress profile of a conventional chemically strengthened glass.

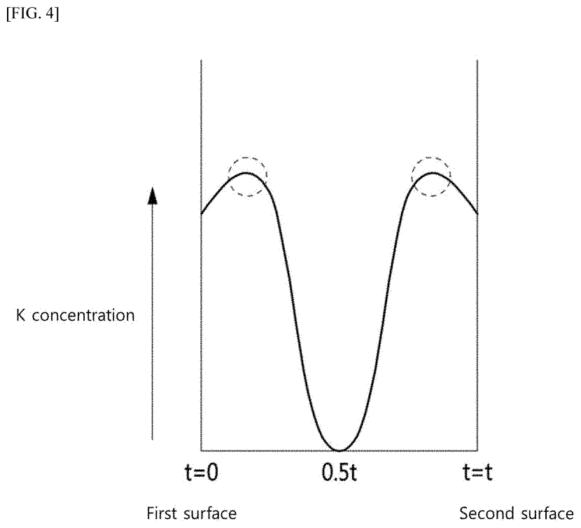

Further, FIG. 3 is a view showing a concentration profile of potassium ions (K⁺) inside the conventional chemically strengthened glass.

Referring to FIG. 3, when potassium ions (K⁺) are injected into the conventional chemically strengthened glass by chemical strengthening, the content of potassium ions (K⁺) in the outermost region is the largest, and as it goes inside, the content of potassium ions (K⁺) gradually decreases.

Accordingly, as it goes inside the stress profile of the conventional chemically strengthened glass as shown in FIG. 1, the magnitude of the compressive stress decreases, and based on the DOL, the compressive stress crosses the tensile stress, and the magnitude of the tensile stress increases.

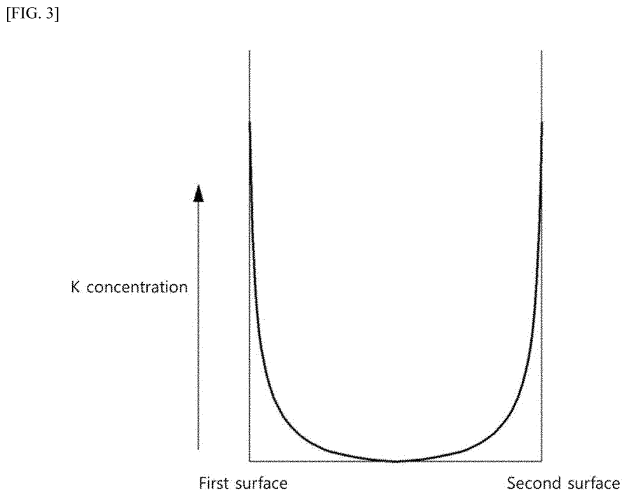

FIG. 2 is a view showing a stress profile of an ultra-thin glass, which is one embodiment of the present disclosure.

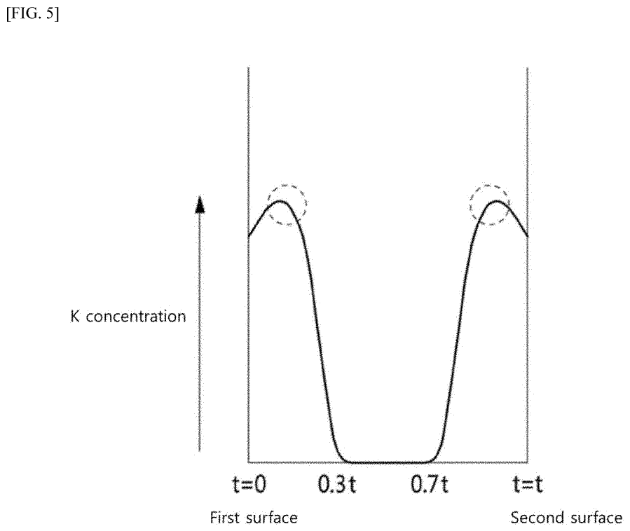

Further, FIG. 4 is a view showing a concentration profile of potassium ions (K⁺) inside an ultra-thin glass as one embodiment of the present disclosure.

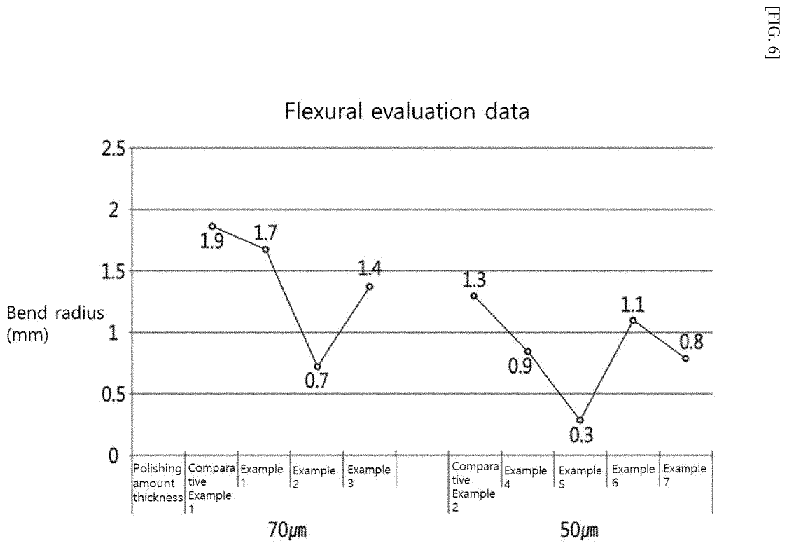

Further, FIG. 5 is a view showing a concentration profile of potassium ions (K⁺) inside an ultra-thin glass as another embodiment of the present disclosure.

Referring to FIGS. 4 and 5, an ultra-thin glass according to the present disclosure has a thickness (t), and the thickness (t) is defined by a first surface and a second surface. The first surface means a region where t=0, and the second surface is defined as a region where t=t.

The ultra-thin glass is chemically strengthened by ion exchange to include a strengthening region containing potassium ions (K⁺), and in the present specification, the depth of layer, as one meaning the depth to the point where the strengthening region is formed, may be formed by including at least one of a first strengthening region and a second strengthening region, which will be described later. FIGS. 4 and 5 show that both the first strengthening region and the second strengthening region are included.

The first strengthening region ts₁ is defined as a region satisfying t₀≤ts₁ 0.5·tₜ, preferably a region satisfying t₀<ts₁<0.3·tₜ,

The second strengthening region ts₂ is defined as a region satisfying 0.5·tₜ≤ts₂<tₜ, preferably a region satisfying 0.7·tₜ≤ts₂<tₜ, the first strengthening region and the second strengthening region are each one meaning a certain region included in the range of a satisfying region, and the range corresponds to the maximum region that the first strengthening region and the second strengthening region can have. That is, the region where the first strengthening region satisfies t₀<ts₁≤0.3·tₜ includes a region where ts₁ is more than to and 0.1·tₜ or less, a region where ts₁ is more than to and 0.2·t₁ or less, etc., indicating that it can have a region where ts₁ is maximally more than to and 0.3·t₁ or less.

FIG. 4 shows regions where the first strengthening region and the second strengthening region satisfy t₀<ts₁≤0.5·tₜ and 0.5·tₜ<ts₂<tₜ, respectively, and FIG. 5 shows a region satisfying t₀<ts₁≤0.3·tₜ and a region satisfying 0.7·tₜ≤ts₂<tₜ.

Referring to FIGS. 4 and 5, a point (t) having the largest content of potassium ions (K⁺) is not included in the first surface and the second surface, but included in the first strengthening region and/or the second strengthening region, and may preferably be formed at a depth of 2% to 30% of the depth of layer. Specifically, if it is explained for example in one embodiment of the present disclosure, when the depth of layer is 15 μm, it means that tₖₘₐₓ exists in the region corresponding to 0.3 μm (2% of the depth of layer) to 4.5 μm (30% of the depth of layer). Due to these characteristics, it is possible to improve the bending resistance of the ultra-thin glass.

This is shown as one embodiment of the present disclosure, and may be appropriately selected according to the user's selection. The point t_{Kmax} at which the concentration of potassium ions (K⁺) is maximum may be included in one or more of the first strengthening region ts₁ and the second strengthening region ts₂.

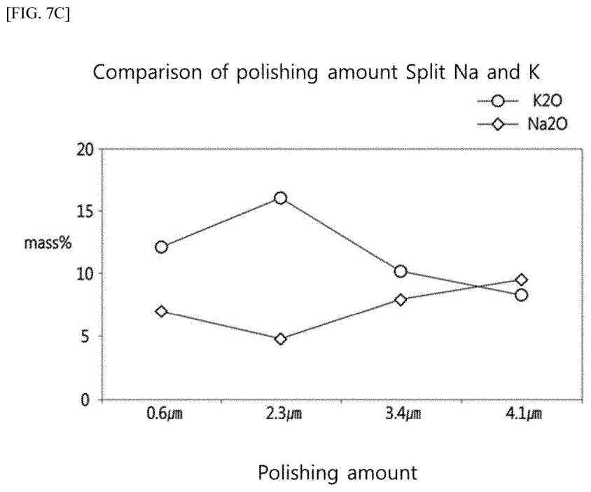

FIG. 7 is a view showing the contents of components by each depth of the ultra-thin glass, which is one embodiment of the present disclosure.

Specifically, FIG. 7A is a view showing the detection of components for a region of 0.6 to 3.6 μm (3 μm section) after polishing the ultra-thin glass, which is one embodiment of the present disclosure, by 0.6 μm from the surface, the detection of components for a region of 2.3 to 5.3 μm (3 μm section) after polishing the ultra-thin glass by 2.3 μM from the surface, the detection of components for a region of 3.4 to 6.4 μm (3 μm section) after polishing the ultra-thin glass by 3.4 μm from the surface, and the detection of components for a region of 4.1 to 7.1 μm (3 μm section) after polishing the ultra-thin glass by 4.1 μm from the surface.

FIG. 7B is a view showing the contents of detected components in a region of a certain thickness range (3 μm section) from the polishing amount as a percentage of the mass, and FIG. 7C is a view showing only the contents of sodium ions (Na⁺) and potassium ions (K⁺) among the detected components shown in FIG. 7B.

Referring to the drawings, they may be in the form that the content of potassium ions (K⁺) inside the ultra-thin glass changes according to the thickness direction, and the content of potassium ions (K⁺) contained in the surface increases and then decreases as it goes inside the ultra-thin glass.

Specifically, even referring to FIG. 7, it can be seen that after polishing by 2.3 μm, potassium ions (K⁺) are most included in the region of 2.3 to 5.3 μm (3 μm section).

Accordingly, as shown in FIG. 2, it exhibits a stress profile distinguished from that exhibited by known chemically strengthened glasses. Specifically, as the content of potassium ions (K⁺) increases and then decreases when it goes from the surface to the inside so that the compressive stress also increases and then decreases when it goes from the surface to the inside, and the compressive stress crosses the tensile stress at the boundary of DOL so that the tensile stress increases.

As described above, the ultra-thin glass according to the present disclosure exhibits an excellent bend radius by the concentration distribution of potassium ions (K⁺) at each point from t₀ to tₜ of the ultra-thin glass. No clear principle for this has been revealed, but if the outermost layer is compared to a passage for ion exchange in the deep part, ion exchange will take place through the corresponding passage, so the concentration of potassium ions (K⁺) in the outermost layer is rather estimated to decrease.

Such a concentration distribution of potassium ions (K⁺) may be one having further improved bending resistance through a chemical polishing process allowing the thickness of the ultra-thin glass after polishing by the chemical polishing process to be 90% or more and less than 100% of the thickness of the ultra-thin glass before polishing, may be specifically one formed by removing the region included in t₀ to 0.05·tₜ with respect to the surface of the ultra-thin glass before polishing of the ultra-thin glass, and may be additionally one formed by removing the region included in 0.95·tₜ to tₜ. The ultra-thin glass according to the present disclosure may be one which is provided with a potassium ion (K⁺) concentration profile and a stress profile disclosed in the present disclosure by removing a certain region as described above, thereby forming the bend radius to be less than 26·t.

The thickness (t) of the ultra-thin glass according to the present disclosure may be appropriately adjusted and used according to the user, but is preferably 20 μm to 100 μm, and more preferably 50 μm to 70 μm. When the thickness is thin, there is a problem in that folds may occur due to folding, and when the thickness is thick, folds do not occur, but there is a disadvantage since the radius of curvature becomes large.

┌Method for Manufacturing Ultra-Thin Glass┘

The method for manufacturing an ultra-thin glass according to the present disclosure relates to a method for manufacturing an ultra-thin glass, the method comprising the steps of: (a) preparing an ultra-thin glass; (b) performing chemical strengthening through an ion displacement solution; and (c) performing chemical polishing through a chemical polishing solution, wherein the ultra-thin glass with a thickness (t) manufactured by the manufacturing method has a bend radius of less than 26·t.

More specifically, the step of preparing of the ultra-thin glass may include a step of preparing an ultra-thin glass by etching one or both surfaces of the glass using an etchant to have an appropriate thickness according to the user's needs. As the etchant, a commonly used etchant or the like may be used, and preferably hydrofluoric acid or the like may be used. The thickness of the ultra-thin glass etched on one or both surfaces using the etchant is not particularly limited, but may be preferably 100 μm or less in terms of bending resistance and the like.

Further, the method may comprise a step of chemically strengthening the prepared ultra-thin glass through an ion displacement solution. Chemical strengthening is a method of strengthening glass by immersing a glass in a molten salt and exchanging alkali ions in the glass with alkali ions in the molten salt. Generally, when a glass containing sodium ions (Na⁺) comes into contact with a salt containing potassium ions (K⁺), the exchange of sodium ions (Na⁺) and potassium ions (K⁺) on the surface proceeds inward. In this case, potassium ions (K⁺) enter the position occupied by sodium ions (Na⁺) in the glass structure, and since the ionic radius of the potassium ion (K⁺) is larger than that of the sodium ion (Na⁺), a compressive force is generated around the network structure to strengthen the glass.

The depth at which potassium ions (K⁺) are substituted by the chemical strengthening is not particularly limited, but is preferably 5 to 20 μm, more preferably 6 to 15 μm in terms of improving bending resistance.

The chemical strengthening step is carried out at a high temperature of 350° C. to 500° C., and in order to prevent damage due to a sudden temperature change of the ultra-thin glass, a process of gradually raising the temperature before immersing the ultra-thin glass in the ion displacement solution may be included.

The ion displacement solution used for the chemical strengthening may include a commonly used ion displacement solution, and for example, may include potassium nitrate (KNO₃).

After the chemical strengthening process, processes for slow cooling and removing impurities may be additionally performed. The processes for slow cooling and removing impurities may include commonly used processes, and may include, for example, performing a washing process in order to remove impurities such as potassium nitrate and the like after the process of performing natural slow cooling in contact with external air.

Subsequently, a step of chemically polishing the ultra-thin glass through a chemical polishing solution may be included.

The polishing thickness may be polished such that the thickness of the ultra-thin glass after polishing becomes 90% or more and less than 100% of the thickness of the ultra-thin glass before polishing, preferably 95% or more and less than 100%, in terms of improving bending resistance.

The chemical polishing solution is not particularly limited as long as it is typically used in a process of polishing an ultra-thin glass, but may include one or more of hydrofluoric acid (HF) and ammonium fluoride (NH₄F).

The ultra-thin glass manufactured by the method for manufacturing an ultra-thin glass includes the same characteristics as those shown in the above-mentioned ┌ultra-thin glass┘.

### MODE FOR CARRYING OUT THE INVENTION

Hereinafter, embodiments of the present disclosure will be specifically described. However, the present disclosure is not limited to the embodiments disclosed below, but may be implemented in various different forms, and only the present embodiments are provided to allow the disclosure of the present disclosure to be complete, and to completely inform those with ordinary skill in the art to which the present disclosure pertains of the scope of the invention, and the present disclosure is only defined by the scope of the claims.

### EXAMPLES AND COMPARATIVE EXAMPLES

### Example 1

A 400 μm thick glass commercially available from Corning was prepared, and an etchant containing hydrofluoric acid was used to manufacture an ultra-thin glass having a thickness of 70 μm. Thereafter, a cell manufactured through chamfering and polishing after cutting it to certain size and shape was immersed in a potassium nitrate melting bath of 350 to 500° C. for 10 to 60 minutes to conduct ion exchange to a depth of layer (DOL) of 6 to 15 μm. In order to prevent breakage of the ultra-thin glass due to rapid temperature change, the temperature was gradually raised to a temperature close to a melting bath temperature before immersing it in the potassium nitrate melting bath. When a temperature near the melting bath temperature was reached, the ultra-thin glass was immersed in the melting bath, and after 10 to 60 minutes from the point of complete immersion, it was taken out of the melting bath and cooled slowly. After performing natural slow cooling of the ultra-thin glass by contacting it with the external air for 5 to 40 minutes, it was immersed in a hot water bath of 45 to 90° C. in order to wash residual potassium nitrate remaining in the ultra-thin glass, and after another 10 to 60 minutes had elapsed, a conventional washing and drying process was performed.

Subsequently, it was immersed in a water bath containing hydrofluoric acid or ammonium fluoride, and the surface was polished by 0.2 μm, and then washing and drying processes were performed to manufacture an ultra-thin glass of Example 1.

### Example 2

An ultra-thin glass of Example 2 was manufactured in the same manner as in Example 1 above except that the surface was polished by 0.7 μm.

### Example 3

An ultra-thin glass of Example 3 was manufactured in the same manner as in Example 1 above except that the surface was polished by 0.9 μm.

### Example 4

An ultra-thin glass of Example 4 was manufactured in the same manner as in Example 1 above except that an ultra-thin glass having a thickness of 50 μm was used and the surface was polished by 0.2 μm.

### Example 5

An ultra-thin glass of Example 5 was manufactured in the same manner as in Example 4 above except that the surface was polished by 0.5 μm.

### Example 6

An ultra-thin glass of Example 6 was manufactured in the same manner as in Example 4 above except that the surface was polished by 0.7 μm.

### Example 7

An ultra-thin glass of Example 7 was manufactured in the same manner as in Example 4 above except that the surface was polished by 0.9 μm.

### Comparative Example 1

A 400 μm thick glass commercially available from Corning was prepared, and an etchant containing hydrofluoric acid was used to manufacture an ultra-thin glass having a thickness of 70 μm. Thereafter, a cell manufactured through chamfering and polishing after cutting it to certain size and shape was immersed in a potassium nitrate melting bath of 350 to 500° C. for 10 to 60 minutes to conduct ion exchange to a depth of layer (DOL) of 6 to 15 μm. In order to prevent breakage of the ultra-thin glass due to rapid temperature change, the temperature was gradually raised to a temperature close to a melting bath temperature before immersing it in the potassium nitrate melting bath. When a temperature near the melting bath temperature was reached, the ultra-thin glass was immersed in the melting bath, and after 10 to 60 minutes from the point of complete immersion, it was taken out of the melting bath and cooled slowly. After performing natural slow cooling of the ultra-thin glass by contacting it with the external air for 5 to 40 minutes, it was immersed in a hot water bath of 45 to 90° C. in order to wash residual potassium nitrate remaining in the ultra-thin glass, and after another 10 to 60 minutes had elapsed, a conventional washing and drying process was performed to manufacture an ultra-thin glass of Comparative Example 1.

### Comparative Example 2

An ultra-thin glass of Comparative Example 2 was manufactured in the same manner as in Comparative Example 1 except that an ultra-thin glass having a thickness of 50 μm was used.

### Experimental Example

Bend Radius Evaluation

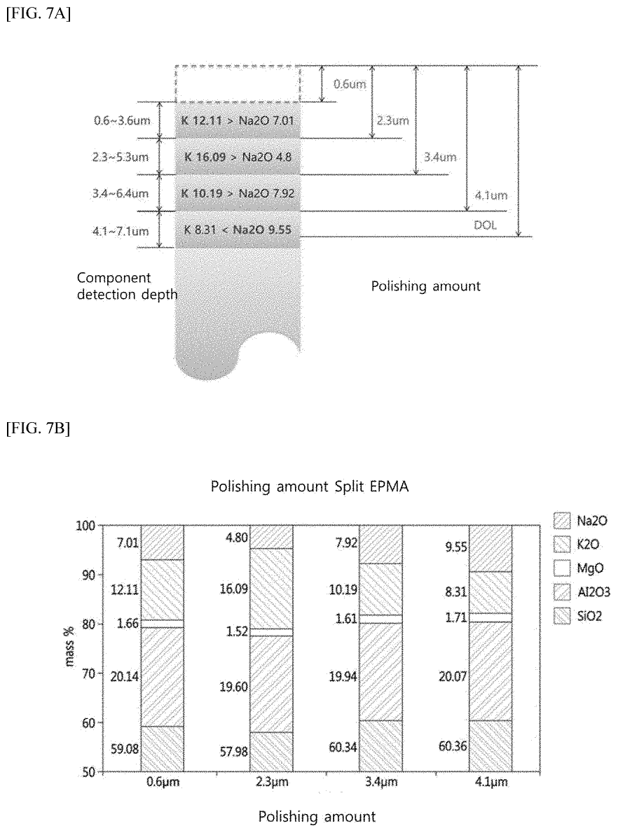

Corning's Gorilla 3 was used as the ultra-thin glasses of the Examples and Comparative Examples to perform the bend radius evaluation at the flexural fracture time of the ultra-thin glasses, thereby showing the results of exhibiting the average values thereof in Table 1 and FIG. 6 below.

For bend radius, the breaking flexural strength and bend radius were quantified by measuring, using Chemilab's Surface Texture Analyzer, the height and force when they are fractured in a way of gradually pressing the fixed glasses in a bent state from the top to the bottom to reduce the bend radius.

Breaking Strength Evaluation

Table 1 below shows the breaking strength values of the ultra-thin glasses of Examples and Comparative Examples measured using Corning's Gorilla 3.

TABLE 1

| | | Bend | Breaking strength | K content |
|---|---|---|---|---|
| | | radius | (average) | Max Depth |
| | Thickness | (average) | (MPa) | (μm) |
| Example 1 | 70 μm_polished by 0.2 μm | 1.7R | 1390 | 1.6 |
| Example 2 | 70 μm_polished by 0.7 μm | 0.7R | 1301 | 1.4 |
| Example 3 | 70 μm_polished by 0.9 μm | 1.4R | 1501 | 1.0 |
| Example 4 | 50 μm_polished by 0.2 μm | 0.9R | 1537 | 1.0 |
| Example 5 | 50 μm_polished by 0.5 μm | 0.3R | 1523 | 1.2 |
| Example 6 | 50 μm_polished by 0.7 μm | 1.1R | 1458 | 0.4 |
| Example 7 | 50 μm_polished by 0.9 μm | 0.8R | 1453 | 1.8 |
| Comparative Example 1 | 70 μm_Ref | 1.9R | 1157 | 2.6 |
| Comparative Example 2 | 50 μm_Ref | 1.3R | 1393 | 1.3 |

Looking at Examples 1 to 3, it can be confirmed that the bend radiuses were decreased to 1.7 R, 0.7 R, and 1.4 R, respectively, compared to 1.9 R of Comparative Example 1, and the breaking strengths were also improved to 1,390 MPa, 1,301 MPa, and 1,501 MPa, respectively, compared to 1,157 MPa of Comparative Example 1. Particularly, looking at Example 2, it can be confirmed that it is formed to a bend radius of 0.7 R, which is not more than 1 R, thereby exhibiting greatly improved properties in terms of foldability.

Looking at also Examples 4 to 7, it can be confirmed that the bend radiuses were decreased to 0.9 R, 0.3 R, 1.1 R, and 0.8 R, respectively, compared to 1.3 R of Comparative Example 2, and the breaking strengths were also improved to 1,537 MPa 1,523 Mpa 1,458 Mpa, and 1,453 Mpa, respectively, compared to 1,393 MPa of Comparative Example 2. Particularly, looking at Example 5, it can be confirmed that it is formed to have a very small bend radius of 0.3 R, thereby exhibiting greatly improved properties in terms of foldability.

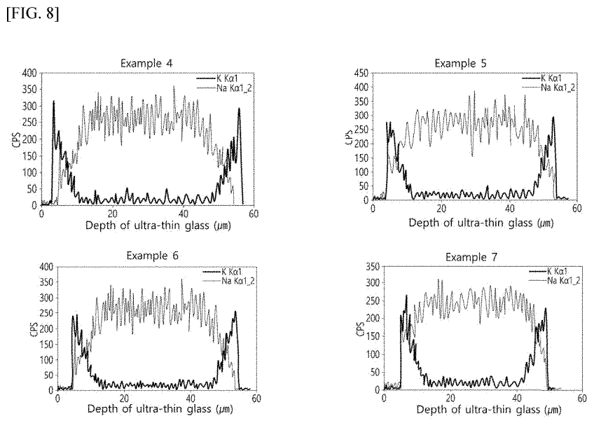

FIG. 8 is views showing the profile of potassium ions (K⁺) for each depth of ultra-thin glasses of Examples 4 to 7. Looking at Table 1 and FIG. 8, the bend radius, the breaking strength, and the maximum depth of the potassium ion (K⁺) concentration do not correspond to a proportional correlation. However, it can be seen from this that, due to the properties of the material called an ultra-thin glass, various factors such as surface defects that may exist probabilistically, thickness deviation, and internal cavity defects that may occur during the manufacture of the ultra-thin glass are mixed, and they are due to complex interactions such as scatter diagram in the strengthening process. As shown in the ultra-thin glass of Example 5, when an appropriate internal potassium ion (K⁺) profile is formed through a process such as polishing, it is possible to manufacture an ultra-thin glass with further improved bending resistance.

### INDUSTRIAL APPLICABILITY

The ultra-thin glass according to the present disclosure has improved bending resistance, and according to the method for manufacturing the ultra-thin glass according to the present disclosure, as it is possible to manufacture the ultra-thin glass having improved bending resistance, there is industrial applicability.

1. An ultra-thin glass having a thickness (t), characterized in that, when the first surface is defined as a point (t₀) with t=0, and the second surface is defined as a point (tₜ) with t=t, the point (t_{Kmax}) at which the concentration of potassium ions (K⁺) is maximum between to and tₜ satisfies at least one of Equations 1 and 2 below, and the ultra-thin glass has a bend radius of less than 26·t.
t₀<t_{Kmax}≤0.5·tₜ [Equation 1]
0.5·tₜ≤t_{Kmax}<tₜ. [Equation 2]

2. The ultra-thin glass of claim 1, wherein t_{Kmax} is formed at a depth of 2% to 30% of the depth of layer.

3. The ultra-thin glass of claim 2, wherein the depth of layer includes at least one region of a first strengthening region ts₁ defined as a region satisfying t₀<ts₁≤0.5·tₜ and a second strengthening region ts₂ defined as a region satisfying 0.5·tₜ≤ts₂<tₜ.

4. The ultra-thin glass of claim 3, wherein the first strengthening region ts₁ is defined as a region satisfying t₀≤ts₁<0.3·tₜ, and the second strengthening region ts₂ is defined as a region satisfying 0.7·tₜ≤ts₂<tₜ.

5. The ultra-thin glass of claim 1, wherein the ultra-thin glass is formed by removing a region included in t₀ to 0.05·tₜ with respect to the surface of the ultra-thin glass before polishing.

6. The ultra-thin glass of claim 5, wherein the ultra-thin glass is formed by further removing a region included in 0.95·tₜ to tₜ.

7. The ultra-thin glass of claim 1, wherein the thickness (t) is 20 μm to 100 μm.

8. The ultra-thin glass of claim 1, wherein the ultra-thin glass has a breaking strength of 1,200 Mpa or more.

9. A method for manufacturing an ultra-thin glass, the method comprising the steps of:
(a) preparing an ultra-thin glass;
(b) performing chemical strengthening through an ion displacement solution; and
(c) performing chemical polishing through a chemical polishing solution,
wherein the ultra-thin glass with a thickness (t) manufactured by the manufacturing method has a bend radius of less than 26·t.

10. The method of claim 9, wherein the step (a) of preparing an ultra-thin glass includes a step of etching one or both surfaces of the glass using an etchant.

11. The method of claim 9, wherein the step (b) of performing chemical strengthening includes a step of raising the temperature before immersing the ultra-thin glass in the ion displacement solution.

12. The method of claim 9, wherein the step (c) of performing chemical polishing is a step of performing polishing such that the thickness of the ultra-thin glass after polishing is 90% or more and less than 100% of the thickness of the ultra-thin glass before polishing.

13. The method of claim 9, wherein the ion displacement solution contains potassium nitrate (KNO₃).

14. The method of claim 9, wherein the chemical polishing solution contains one or more of hydrofluoric acid (HF) and ammonium fluoride (NH₄F).
